(19) United States
(12) Patent Application Publication
(10) Pub. No.: US 2020/0001545 A1
(43) Pub. Date: Jan. 2, 2020

(54) FILM PASTING DEVICE AND METHOD OF PASTING FILM

(71) Applicant: KAWASAKI JUKOGYO KABUSHIKI KAISHA, Kobe-shi, Hyogo (JP)

(72) Inventors: Masayuki WATANABE, Kobe-shi (JP); Yuichi OGITA, Kobe-shi (JP); Hiroki KOKUSHI, Kakogawa-shi (JP)

(73) Assignee: KAWASAKI JUKOGYO KABUSHIKI KAISHA, Kobe-shi, Hyogo (JP)

(21) Appl. No.: 16/483,840

(22) PCT Filed: Feb. 5, 2018
(86) PCT No.: PCT/JP2018/003796

§ 371 Date: Aug. 6, 2019

(30) Foreign Application Priority Data
Feb. 6, 2017 (JP) 2017-019825

(51) Int. Cl. B29C 65/78; B29C 65/48; B25J 9/00

(52) U.S. Cl. CPC B29C 65/7847; B25J 9/0087; B29C 65/48

(57) ABSTRACT

A film pasting device and a method of pasting a film, which can easily paste the film with reduced residual air, are provided. A control part controls movements of a suction unit and a pressing unit so that a portion of a film to be pasted is inclined with respect to a surface of a pasting position of a terminal, and the pressing unit sequentially pastes an adhesive part in a pasting direction from one area to the other area, while pressing the portion of the film to be pasted, to paste the film to the terminal.

### TECHNICAL FIELD

The present disclosure relates to a film pasting device and a method of pasting a film, which paste the film to a target object.

### BACKGROUND ART

Conventionally, devices which paste a film to a target object are used. For example, Patent Document 1 discloses a pasting device for an adhesive sheet which pastes an adhesive sheet to the target object. Patent Document 1 discloses the pasting device for the adhesive sheet which can reduce residual air by a pressing part pasting the adhesive sheet while pressing the adhesive sheet.

### REFERENCE DOCUMENT OF CONVENTIONAL ART

### Patent Document

[Patent Document 1] JP2014-061995A

### DESCRIPTION OF THE DISCLOSURE

### Problems to be Solved by the Disclosure

However, when pasting the adhesive sheet to the target object by the pasting device for the adhesive sheet disclosed in Patent Document 1, it is necessary to set the pressing force by the pressing part as a suitable magnitude for every position. Thus, the pressing force by the pressing part needs to be set as a suitable magnitude beforehand, which results in a longer pasting time and a correspondingly increased cost.

Therefore, the present disclosure is made in view of the above situations, and one purpose thereof is to provide a film pasting device and a method of pasting a film, which can easily paste the film with reduced residual air.

### SUMMARY OF THE DISCLOSURE

A film pasting device according to one aspect of the present disclosure includes a movable holding part configured to hold a film formed with an adhesive part having adhesiveness in one surface of the film, a pressing part configured to press an area of the film that contacts a target object from other surface side opposite from the one surface when the adhesive part contacts the target object, and a control part configured to control movement of the holding part and movement of the pressing part. The control part controls the movements of the holding part and the pressing part so that the holding part holding the film moves to position the film at a pasting position of the target object, and incline a portion of the film to be pasted with respect to a surface of the pasting position of the target object, and the pressing part sequentially pastes the adhesive part in a pasting direction from one area to the other area, while pressing the portion of the film to be pasted, to bring the adhesive part into contact with the target object and past the film to the target object.

### Effect of the Disclosure

Since the film is pasted with the reduced residual air by the simple method, the film can be pasted at high speed and many films can be pasted in a short time. Therefore, the cost required for pasting of the films can be reduced.

### BRIEF DESCRIPTION OF DRAWINGS

FIG. 1(a) is a plan view of a film pasting device according to one embodiment of the present disclosure, and FIG. 1(b) is a side view of the film pasting device.

FIG. 2 is a front view of a film pasting device main body of the film pasting device of FIG. 1.

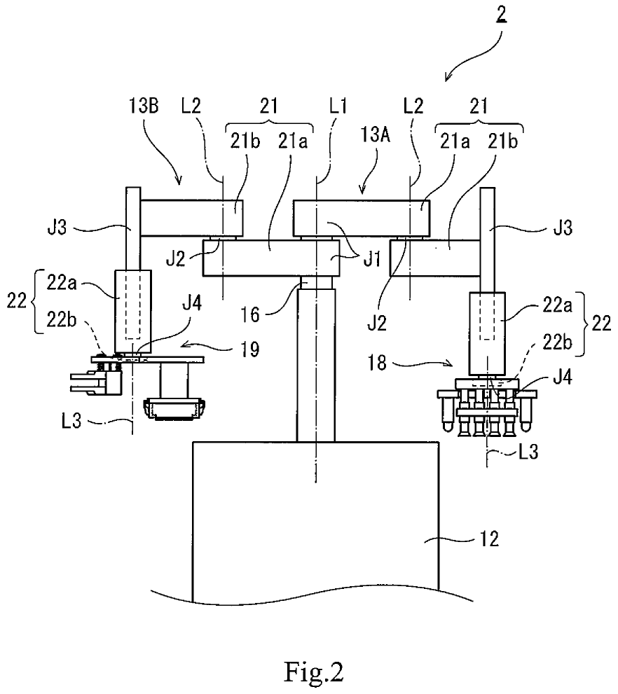

FIG. 3(a) is a plan view of a suction unit gripped by a first holding part of the film pasting device main body of FIG. 2, and FIG. 3(b) is a front view of the suction unit.

FIG. 4(a) is a plan view of a multi-function hand part gripped by a second holding part of the film pasting device main body of FIG. 2, FIG. 4(b) is a front view of a wiper unit of the multi-function hand part, FIG. 4(c) is a side view of a peeling unit, and FIG. 4(d) is a side view of a pressing unit.

FIG. 5 is a block diagram illustrating a configuration of a control system of the film pasting device main body.

FIG. 6 is a flowchart illustrating a flow when pasting a film to a terminal by the film pasting device of FIG. 1.

FIGS. 7(a) to 7(e) are views illustrating processes when wiping the terminal before the film is pasted by the wiper unit of FIG. 4(b).

FIGS. 8(a) to 8(d) are views illustrating processes when sucking the film by the suction unit of FIG. 3.

FIGS. 9(a) to 9(d) are views illustrating processes when peeling a protection sheet from the film by the peeling unit of FIG. 4(c).

FIGS. 10(a) to 10(f) are views illustrating processes when pasting the film to the terminal, while pressing the film toward the terminal using the pressing unit of FIG. 4(d).

FIGS. 11(a) to 11(e) are views illustrating processes when wiping the terminal after the film is pasted by the wiper unit of FIG. 4(b).

### MODE FOR CARRYING OUT THE DISCLOSURE

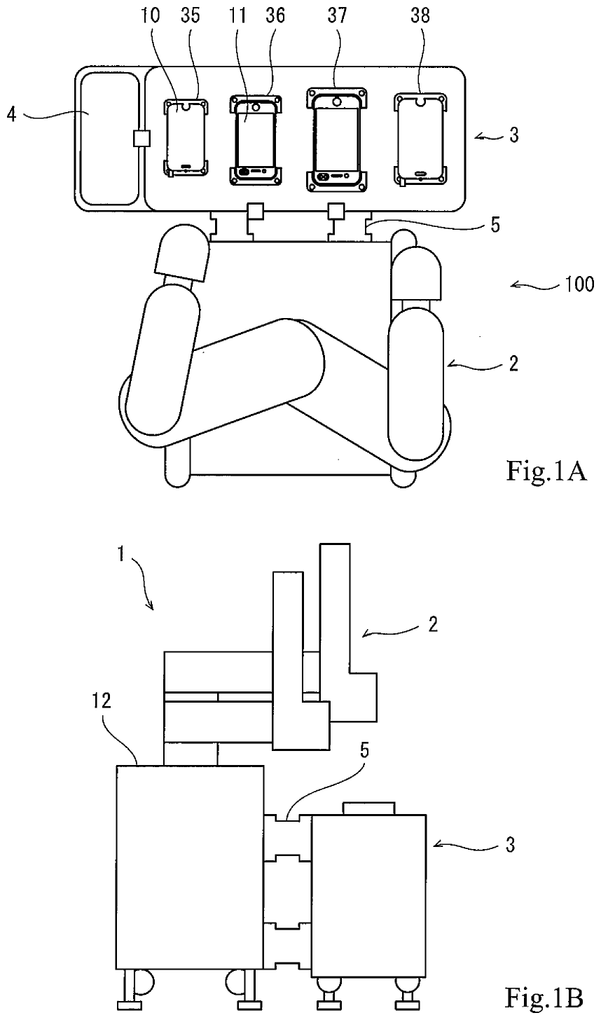

Hereinafter, a film pasting device and a method of pasting a film according to one embodiment of the present disclosure will be described with reference to the accompanying drawings. FIG. 1 illustrates a film pasting device 100 of this embodiment. FIG. 1(a) illustrates a plan view of the film pasting device 100, and FIG. 1(b) illustrates a side view of the film pasting device 100. In the film pasting device 100 of this embodiment, a film 10 used is formed transparently. The film pasting device 100 is to paste the transparent film 10 onto a screen of a terminal 11, such as a cellular phone and a tablet, to protect the screen of the terminal 11.

Adhesive is applied to one of the surfaces of the film 10 to be pasted so that the surface forms an adhesive part having adhesiveness. By bringing this adhesive part into contact with a target object, the film 10 is pasted to the target object. In this embodiment, the adhesive part of the film 10 is brought into contact with a screen portion of the terminal 11 as the target object so that the film 10 is pasted to the screen portion of the terminal 11.

A protection sheet is peelably attached to the film 10, having not yet been pasted, at the side where the adhesive part is formed. The protection sheet covers, when the adhesive part is not used, one surface of the film 10 where the adhesive part is formed to protect the adhesive part.

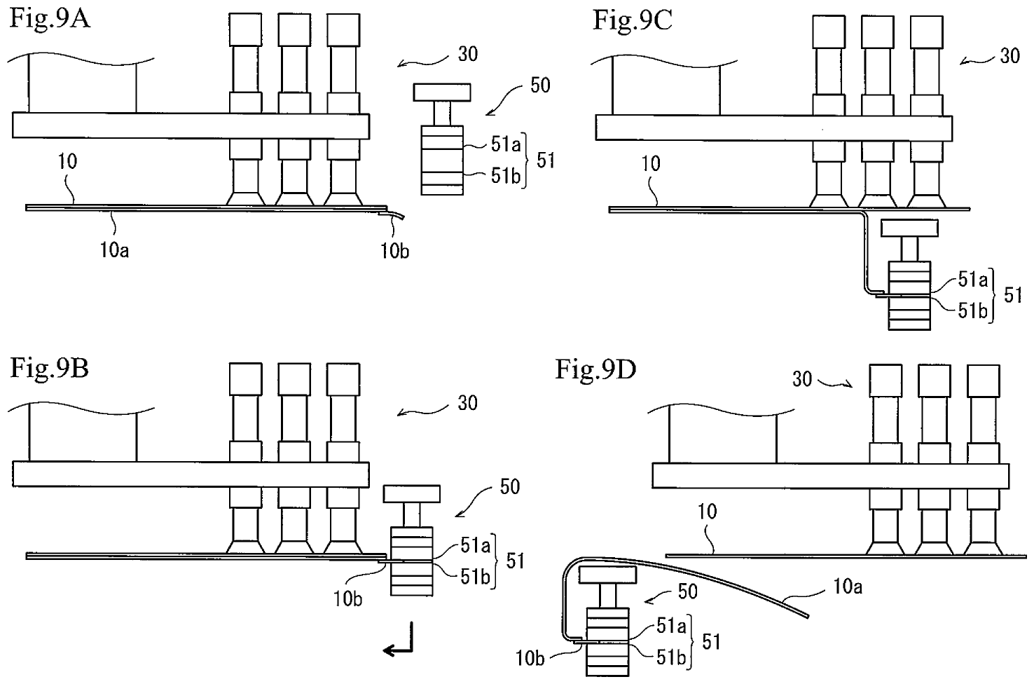

A grip part (a grip part 10b in FIGS. 9(a) to 9(d)) for being gripped when peeling the protection sheet from the film is formed in the protection sheet. The grip part is located in an area separated from the adhesive part, and is gripped by a peeling unit 50 (described later) when peeling the protection sheet from the film 10.

The film pasting device 100 includes a film pasting device main body 2 and a table 3. A connecting member 5 which connects the film pasting device main body 2 with the table 3 is disposed between the film pasting device main body 2 and the table 3.

Next, a structure of the table 3 is described. The table 3 includes a disposal box 4, a film feed position 35, and a terminal set position 36.

The protection sheet which is peeled by the peeling unit 50 (described later) is thrown into the disposal box 4. The disposal box 4 is a place where the protection sheets are stored temporarily, in order to later discard them collectively.

A plurality of films 10 which have not yet been pasted are stacked at the film feed position 35. The terminal 11 as the target object is set to the terminal set position 36.

Note that, in this embodiment, the table 3 is constructed so that two different types of terminals can be set or placed. Thus, the table 3 is provided with a terminal set position 37 for a terminal of a different model form the terminal 11. A film feed position 38 is also formed on the table 3 at which films for being pasted to the terminal of the different mode from the terminal 11 is stacked. Thus, the table 3 is constructed so that the two types of terminals and the films corresponding to the terminals are disposed at once. Note that the present disclosure is not limited to this structure, and three or more terminal set positions corresponding to three or more different types or models, and corresponding film feed positions may be formed.

The film pasting device main body 2 is comprised of a horizontal articulated dual-arm robot having a pair of robotic arms 13.

The film pasting device main body 2 includes a first robotic arm 13A and a second robotic arm 13B. A first holding part 18 is provided to a tip-end part of the first robotic arm 13A. A second holding part 19 is provided to a tip-end part of the second robotic arm 13B. Below, when not distinguishing the first robotic arm 13A from the second robotic arm 13B or vice versa, they may simply be referred to as “the robotic arm(s) 13.”

The film pasting device main body 2 includes a control part 14 and a vacuum generator (not illustrated).

The control part 14 is provided, for example, inside a support base 12 of the film pasting device main body 2. However, it is limited to this structure, and the control part 14 may be provided inside the robotic arm 13. Alternatively, it may be provided to other vacant spaces.

The vacuum generator is, for example, a vacuum pump or CONVUM®, and is provided, for example, inside the table 3. However, it is not limited to this structure, and it may be provided at other locations, such as inside the robotic arm 13. The vacuum generator is connected with a suction unit 30 (described later) through piping (not illustrated). The piping is provided with, for example, an on-off valve (not illustrated), and the on-off valve opens and closes the piping. The operation of the vacuum generator and the opening and closing of the on-off valve are controlled by a control device.

The first robotic arm 13A moves the first holding part 18 within a given operating range. Moreover, the second robotic arm 13B moves the second holding part 19 within the given operating range. The robotic arm 13 is, for example, a horizontal articulated robotic arm, and includes an arm part 21 and a wrist part 22. Moreover, the first robotic arm 13A and the second robotic arm 13B are operable independently or dependently.

The first holding part 18 and the second holding part 19 are constructed to be grippable of hand parts having respective functions. When the hand parts demonstrate the functions, given processings can be performed to the terminal and the film to be pasted.

The film pasting device main body 2 includes the support base 12 and a base shaft 16 extending vertically upward from the support base 12. The base shaft 16 is rotatably attached to the support base 12.

The arm parts 21 are attached to the base shaft 16 so as to extend horizontally. The arm parts 21 are attached rotatably centering on the base shaft 16.

Each arm part 21 includes a first link 21a and a second link 21b. The first link 21a and the second link 21b are supported so as to be rotatable to each other horizontally. The first robotic arm 13A and the second robotic arm 13B are connected with the base shaft 16 through the arm parts 21.

The arm parts 21 position the wrist parts 22 attached to the tip-end parts of the first robotic arm 13A and the second robotic arm 13B at arbitrary positions within the operating range.

Each first link 21a is coupled at a base-end part to the base shaft 16 of the support base 12 through a rotary joint J1, and is rotatable on a rotation axis L1 passing through an axial center of the base shaft 16. The second link 21b is coupled to a tip-end part of the first link 21a through a rotary joint J2, and is rotatable on a rotation axis L2 defined at the tip-end part of the first link 21a.

The wrist part 22 changes a mechanism attached to a tip end thereof into an arbitrary posture. The wrist part 22 includes an elevating part 22a and a rotary part 22b. The elevating part 22a is coupled to a tip-end part of the second link 21b through a linear-motion joint J3, and is ascendable and descendable with respect to the second link 21b. The rotary part 22b is coupled to a lower-end part of the elevating part 22a through a rotary joint J4, and is rotatable on a rotation axis L3 defined at the lower end of the elevating part 22a.

In this embodiment, the rotation axes L1-L3 are parallel to each other, and for example, extend in the vertical direction. Moreover, the extending directions of the rotation axes L1-L3 and the elevating directions of the elevating parts 22a are parallel to each other.

Each arm 13 is provided with, so as to be associated with the respective joints J1-J4, servo motors for drive (not illustrated) and encoders (not illustrated) which detect rotational angles of the servo motors. Moreover, the rotation axis L1 of the first robotic arm 13A and the rotation axis L1 of the second robotic arm 13B are located on the same straight line, and the first link 21a of the first robotic arm 13A and the first link 21a of the second robotic arm 13B are provided with a height difference therebetween.

Next, the hand part which can be gripped by each of the first holding part 18 and the second holding part 19 is described. In this embodiment, the first holding part 18 grips a suction unit (a holding part, a suction part) 30 as the hand part.

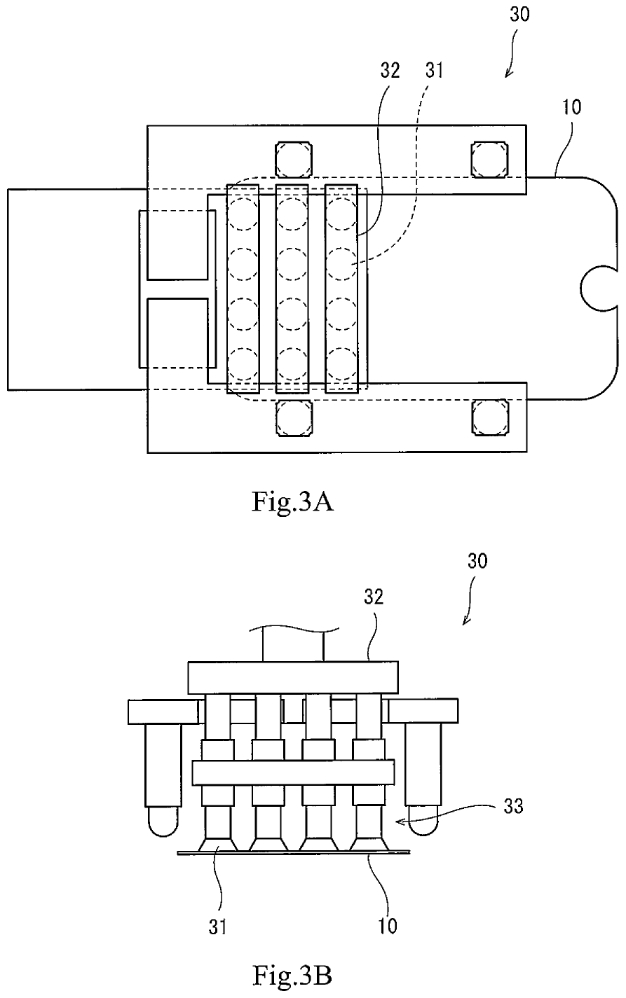

The suction unit 30 is described. FIG. 3(a) illustrates a plan view of the suction unit 30, and FIG. 3(b) illustrates a front view of the suction unit 30. As illustrated in FIGS. 3(a) and (b), a plurality of suction ports 31 are provided to the suction unit 30. Since the suction unit 30 of this embodiment is provided with four suction ports 31 per one row and there are three rows, the total of twelve suction ports 31 is provided.

The suction unit 30 is provided with support members 32, and four suction ports of one row are attached to one support member 32. The support member 32 is provided to each of the three rows of suction ports 31, and three support members 32 are attached to the suction unit 30. A suction pipe 33 is attached to the support member 32 so as to extend from the support members 32 to the suction ports 31. A suction force from the vacuum generator is transmitted to the suction ports 31 through the suction pipe 33 to perform suction by the suction ports 31.

Each suction port 31 of the suction unit 30 is connected with the vacuum generator through the piping described above so that it is possible to suck air from the suction port 31. By performing the suction from the suction ports 31 of the suction unit 30, the film 10 can be sucked and held at tip ends of the suction ports 31. The suction unit 30 sucks the opposite surface of the film 10 from the surface where the adhesive part is formed.

Moreover, since the suction unit 30 is gripped by the first holding part 18, it is movable within the given operating range by driving the first robotic arm 13A.

Moreover, the second holding part 19 grips the multi-function hand part 70 which is integrally constituted by a wiper unit 40, a peeling unit 50, and a pressing unit 60, as the hand part.

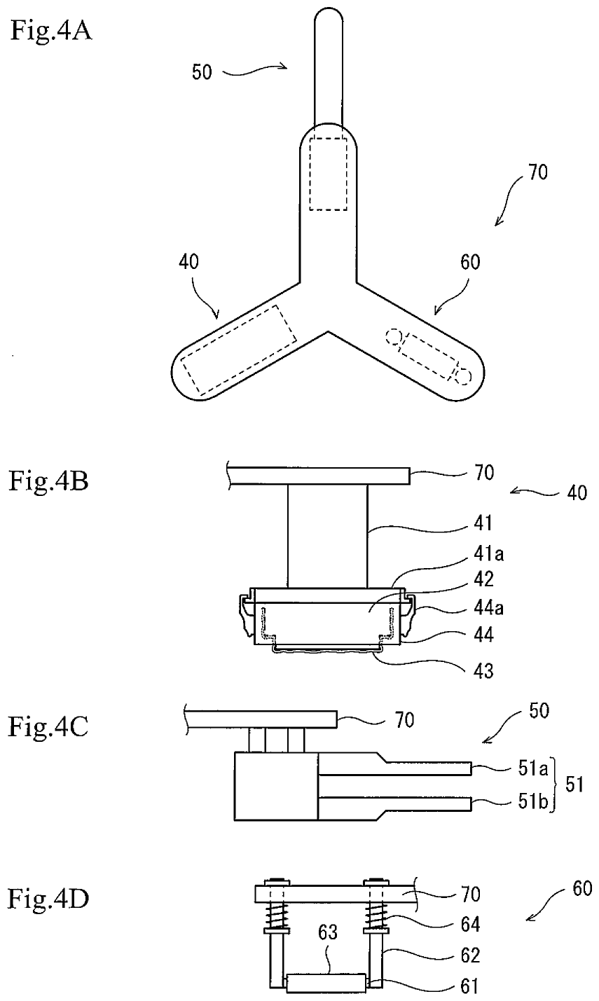

FIG. 4(a) illustrates a plan view of the multi-function hand part 70. In this embodiment, the wiper unit 40, the peeling unit 50, and the pressing unit 60 are attached to one multi-function hand part 70.

The wiper unit (wiper member) 40 is described. FIG. 4(b) illustrates a front view of the wiper unit 40.

The wiper unit 40 includes a cylinder part 41, a flange part 42, a wiping part 43, and a covering part 44. The cylinder part 41 is attached to the multi-function hand part 70. The flange part 42 is attached to a lower part of the cylinder part 41. The cylinder part 41 is provided with a base portion 41a extending outwardly. The covering part 44 is attached to the outside of the flange part 42. The covering part 44 is detachably attached to the base portion 41a through a detachable mechanism 44a. The wiping part 43 is attached to the flange part 42 and the covering part 44 by pinching a part of the wiping part 43 between the flange part 42 and the covering part 44. Thus, the wiping part 43 is replaceably attached to the cylinder part 41.

Moreover, a central part of the wiping part 43 is exposed outside through the covering part 44. Therefore, the central part of the wiping part 43 is constructed so as to be brought in contact with the object to be wiped. The wiper unit 40 reciprocates while the wiping part 43 contacts the object to be wiped, and the wiping part 43 wipes off the spot adhered to or cleans the object to be wiped, to perform the wiping. In this embodiment, by wiping off the surface of the terminal by the wiping part 43, spots, such as dust and oil, which are adhered to the surface of the terminal can be wiped off and removed from the surface of the terminal.

When the wiping is repeated with the same wiping part 43 and the wiping is fully performed by the wiping part 43, the wiping part 43 which is used till then is removed, and a new wiping part 43 is attached to replace the wiping part 43 with a new one. Therefore, by replacing the wiping part 43 at a suitable frequency, the wiping can be continuously performed by the clean wiping part 43.

Next, the peeling unit (peeling part) 50 is described. FIG. 4(c) illustrates a side view of the peeling unit 50. The peeling unit 50 is provided with a chuck part 51. The chuck part 51 is provided with an upper chuck portion 51a and a lower chuck portion 51b which are constructed to be mutually movable in the vertical direction.

The upper chuck portion 51a and the lower chuck portion 51b move so as to approach each other, and the grip part of the protection sheet of the film 10 is pinched vertically. Thus, the grip part of the protection sheet is grippable.

When the peeling unit 50 grips the grip part to hold the protection sheet, and the peeling unit 50 is moved so as to be separated from the film 10 in that state, it is possible to peel the protection sheet from the film 10. Moreover, when the upper chuck portion 51a and the lower chuck portion 51b of the chuck part 51 are moved so as to be separated from each other, the peeling unit 50 releases the grip of the film 10.

Next, the pressing unit (pressing part) 60 is described. FIG. 4(d) illustrates a side view of the pressing unit 60. The pressing unit 60 includes a rotation shaft 61, support members 62 which support the rotation shaft 61, and a roller 63 disposed rotatably centering on the rotation shaft 61. The roller 63 is constructed to be rollable on an area of the film 10 which contacts the terminal 11, while pressing the film 10 from the opposite surface from the surface where the adhesive part is formed. The support members 62 are attached to the multi-function hand part 70 through springs 64. The support members 62 are attached to the multi-function hand part 70 so as to be movable upwardly and downwardly in the vertical direction, while being biased downwardly in the vertical direction. Thus, the roller 63 is constructed to be movable in the horizontal direction by rotating while being biased downwardly in the vertical direction. Therefore, the roller 63 can move horizontally, while pressing downwardly in the vertical direction the film 10 to be pressed.

Therefore, when the adhesive part of the film 10 contacts the terminal 11, the pressing unit 60 is capable of pressing the area of the film 10 which contacts the terminal 11 from the other surface side which is the opposite side from the surface where the adhesive part is formed.

Since the multi-function hand part 70 is gripped by the second holding part 19, it can be moved within the given operating range by driving the second robotic arm 13B. Moreover, the multi-function hand part 70 is constructed to be rotatable on the rotation axis L3 with respect to the second holding part 19. When the multi-function hand part 70 rotates on the rotation axis L3, the posture of the multi-function hand part 70 can be changed. That is, by rotating the multi-function hand part 70 on the rotation axis L3, the unit located at the position opposing to the film 10 or the terminal 11 can be changed. Thus, the unit to be used, which is attached to the multi-function hand part 70, can be changed quickly to one of the wiper unit 40, the peeling unit 50, and the pressing unit 60. Thus, after the processing to the terminal by one unit is performed, the change to another unit which performs the next processing to the terminal can be performed at high speed.

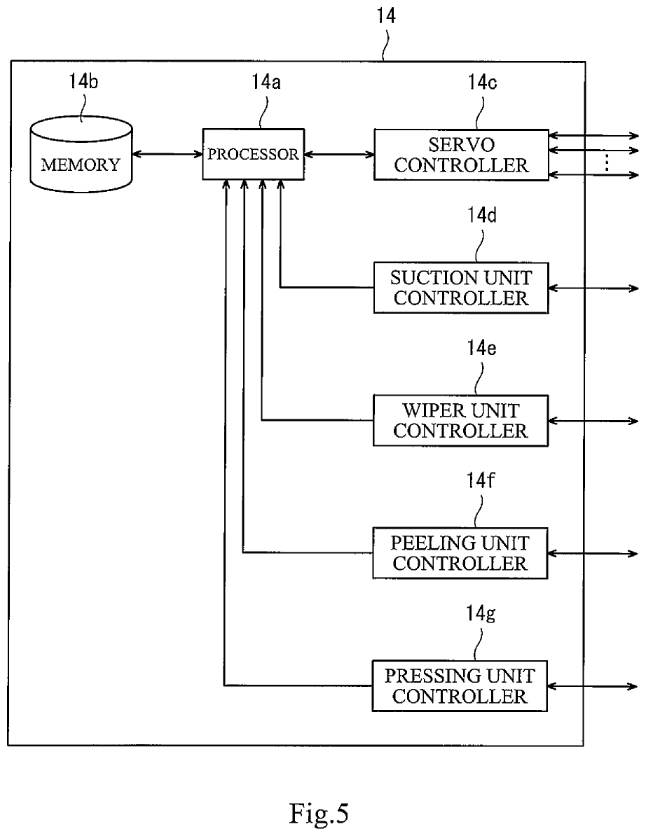

Next, the control part 14 which controls operation of the film pasting device main body 2 is described. FIG. 5 is a block diagram schematically illustrating one example of a configuration of the control system of the film pasting device main body.

As illustrated in FIG. 5, the control part 14 includes a processor 14a, a memory 14b, a servo controller 14c, a suction unit controller 14d, a wiper unit controller 14e, a peeling unit controller 14f, and a pressing unit controller 14g.

The control part 14 is a robot controller provided with a computer, such as a microcontroller, for example. Note that the control part 14 may be comprised of a sole control part 14 which carries out a centralized control, or may be comprised of a plurality of control parts 14 which collaboratively carry out a distributed control.

The memory 14b stores information on a basic program as the robot controller, various fixed data, etc. The processor 14a controls various operations of a robot 1 by reading and executing software, such as the basic program stored in the memory 14b. That is, the processor 14a generates control commands for the robot 1, and outputs them to the servo controller 14c, the suction unit controller 14d, the wiper unit controller 14e, the peeling unit controller 14f, and the pressing unit controller 14g. Based on the control commands generated by the processor 14a, the servo controller 14c controls the drive of the servo motors corresponding to the respective joints J1-J4 of the first robotic arm 13A and the second robotic arm 13B of the robot 1.

The suction unit controller 14d controls the suction, movement, and operation of the suction unit 30 by controlling the vacuum generator and actuator based on the control command generated by the processor 14a. The wiper unit controller 14e controls the movement and operation of the wiper unit 40 by controlling the actuator based on the control command generated by the processor 14a. The peeling unit controller 14f controls the movement and operation of the peeling unit 50 by controlling the actuator based on the control command generated by the processor 14a. The pressing unit controller 14g control the movement and operation of the pressing unit 60 by controlling the actuator based on the control command generated by the processor 14a.

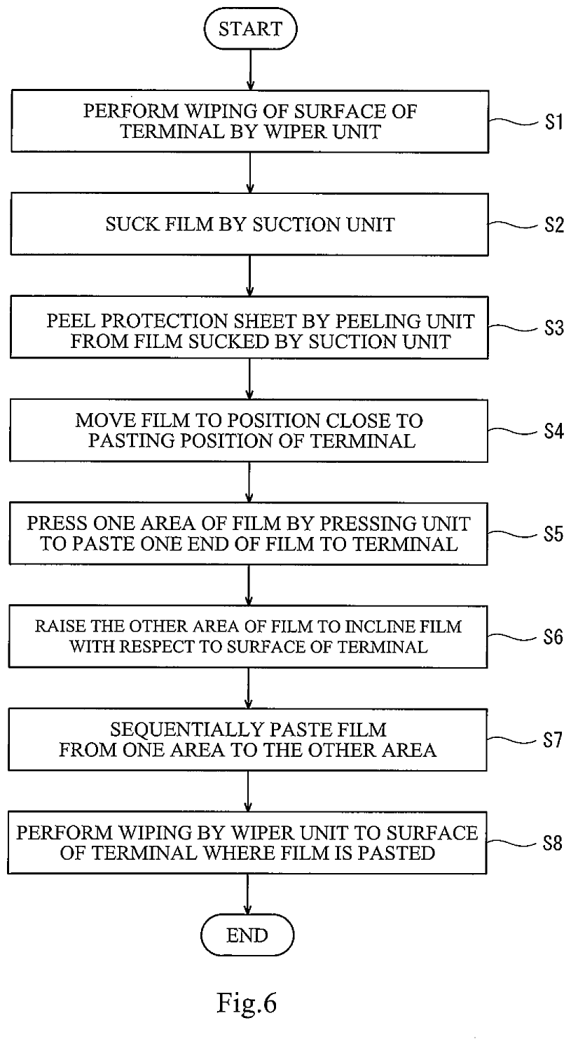

Operation of the film pasting device 100 configured as described above when pasting the film 10 to the terminal 11 is described. FIG. 6 illustrates a flowchart when pasting the film 10 by the film pasting device 100. Below, each process of pasting the film 10 to the terminal 11 is described with reference to the flowchart of FIG. 6.

First, before pasting, the wiping is performed by the wiper unit 40 at the surface of the terminal 11 as the target object (S1). In that case, by rotating the multi-function hand part 70 and moving the multi-function hand part 70, the position and posture of the multi-function hand part 70 are adjusted so that the wiping part 43 of the wiper unit 40 is located at the position opposing to the terminal 11.

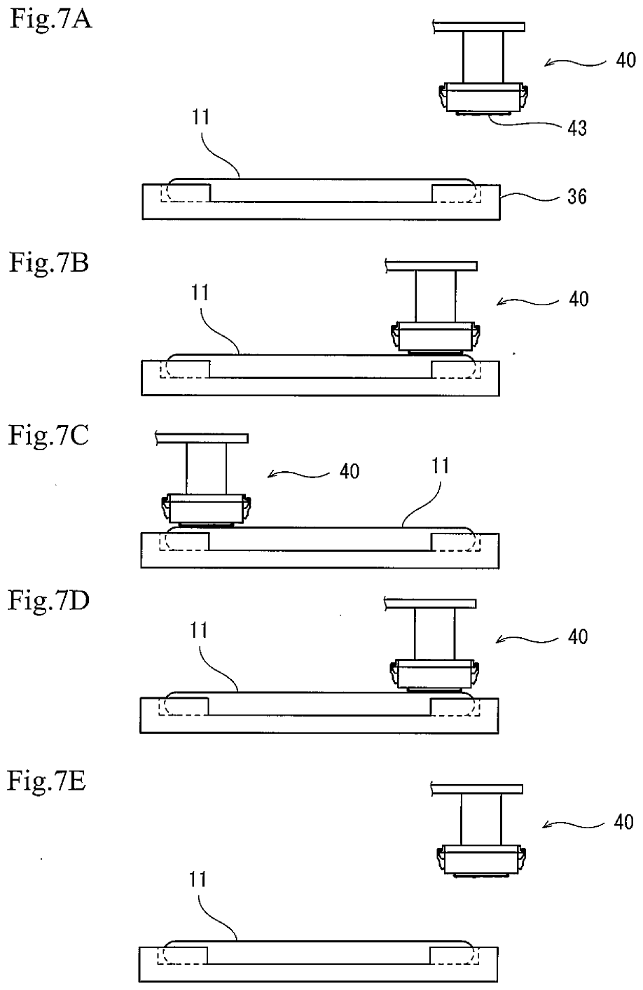

FIGS. 7(a) to 7(e) each illustrates a side view of the wiper unit 40 and the terminal 11 at each process when the wiper unit 40 performs the wiping of the surface of the terminal. As illustrated in FIGS. 7(a) and 7(b), the wiper unit 40 moves toward the terminal 11 in the state where the film has not been pasted yet.

As illustrated in FIG. 7(b), when the wiper unit 40 reaches the position at which the wiping part 43 of the wiper unit 40 contacts the surface of the terminal 11, then, as illustrated in FIGS. 7(c) and 7(d), the wiping part 43 reciprocates while contacting the surface of the terminal 11. In this embodiment, the wiper unit 40 is brought in contact with an end of the terminal 11.

By the wiper unit 40 reciprocating while the wiping part 43 contacting the surface of the terminal 11, the wiping part 43 can wipe off spots, such as dust and oil, on the surface of the terminal 11 to clean the surface of the terminal 11.

When the wiper unit 40 reciprocates a given number of times on the surface of the terminal 11 and the wiping of the wiper unit 40 is finished, the wiper unit 40 is moved so as to be separated from the terminal 11, as illustrated in FIG. 7(e).

By performing the wiping on the surface of the screen portion of the terminal 11, the spots, such as dust and oil, are removed from the surface of the terminal. Thus, the surface of the terminal 11 before pasting the film 10 is cleaned. As described above, the wiper unit 40 is constructed so that it is possible to perform the wiping at the pasting position of the film 10 in the terminal 11 before pasting the film 10 to the terminal 11.

Next, one film 10 is picked up from the plurality of films 10 stacked at the film feed position 35 by the suction of the suction unit 30 (S2). When taking out the film 10, only one film 10 located at the topmost at the film feed position 35 is taken out.

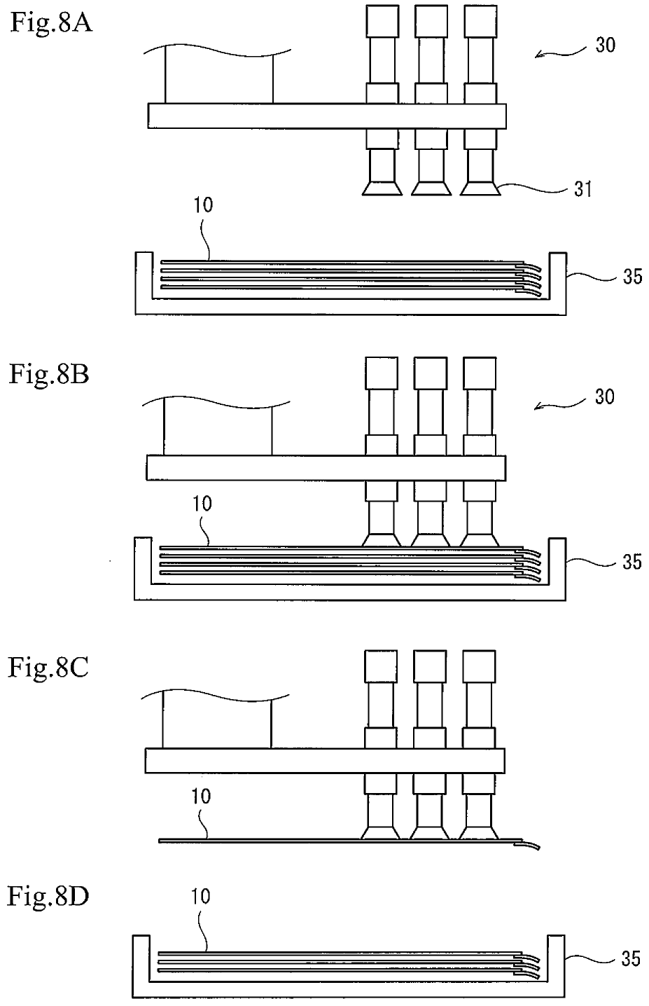

FIGS. 8(a) to 8(d) each illustrates a side view of the suction unit 30 and the film 10 at each process when picking out the film 10 from the films 10 stacked at the film feed position 35.

As illustrated in FIGS. 8(a) and 8(b), the suction unit 30 is moved toward the film feed position 35. The suction unit 30 is moved and the suction unit 30 is positioned at the position opposing to the film feed position 35 where the films 10 are stacked. As illustrated in FIG. 8(b), when the suction unit 30 contacts the topmost film 10 among the films 10 stacked at the film feed position 35, the suction of the film 10 is performed by the suction unit 30.

In the suction by the suction unit 30, the film is sucked to the suction ports 31 and the film 10 is held by sucking air from the suction ports 31 while the film 10 is brought in contact with the suction ports 31 (holding process). When the film 10 is sucked by the suction unit 30, the suction unit 30 is moved so as to be separated from the film feed position 35 while holding the film 10 by the suction, as illustrated in FIG. 8(c).

Next, the peeling of the protection sheet 10a from the film 10 is performed by the peeling unit 50 (S3).

FIGS. 9(a) to 9(d) each illustrates the film 10, the suction unit 30, and the peeling unit 50 at each process when peeling the protection sheet 10a from the film 10 by the peeling unit 50. As illustrated in FIGS. 9(a) to 9(d), the grip part 10b is attached to the protection sheet 10a of the film 10 in this embodiment.

As illustrated in FIGS. 9(a) and 9(b), the chuck part 51 of the peeling unit 50 is moved toward the grip part 10b of the protection sheet 10a of the film 10. At this time, by moving the multi-function hand part 70 while rotating the multi-function hand part 70, the peeling unit 50 is located at a position where the chuck part 51 can grip the grip part 10b.

As illustrated in FIG. 9(b), when the peeling unit 50 reaches a position where it sandwiches the grip part 10b between the upper chuck portion 51a and the lower chuck portion 51b, the upper chuck portion 51a and the lower chuck portion 51b are moved so that they approach each other, and the peeling unit 50 pinches the grip part 10b. Thus, the grip part 10b is gripped by the peeling unit 50.

When the peeling unit 50 grips the grip part 10b, it then moves in this state. As illustrated by an arrow in FIG. 9(b), once the peeling unit moves downwardly in the vertical direction, it then moves toward the other end opposite from one end where the grip part 10b is formed in the film 10.

As illustrated in FIG. 9(c), as the peeling unit 50 moves toward the other end opposite from one end where the grip part 10b is formed in the film 10, the peeling of the protection sheet 10a from the film 10 progresses.

As illustrated in FIG. 9(d), when the peeling unit 50 passes through the other end opposite from one end where the grip part 10b is formed in the film 10 and continues moving from there in the same direction, the protection sheet 10a is separated from the film 10. When the protection sheet 10a is separated from the film 10, the peeling of the protection sheet 10a from the film 10 is finished.

The peeling unit 50 moves to a position above the disposal box 4, while gripping the protection sheet 10a peeled off. When the peeling unit 50 reaches above the disposal box 4, the upper chuck portion 51a and the lower chuck portion 51b are moved there so as to be separated from each other, and the chuck part 51 of the peeling unit 50 releases the grip of the protection sheet 10a. By the chuck part 51 releasing the grip of the protection sheet 10a, the protection sheet 10a falls into the disposal box 4, and the protection sheet 10a is thrown into the disposal box 4 for disposal. Thus, the protection sheet 10a peeled off by the peeling unit 50 is disposed in the disposal box 4.

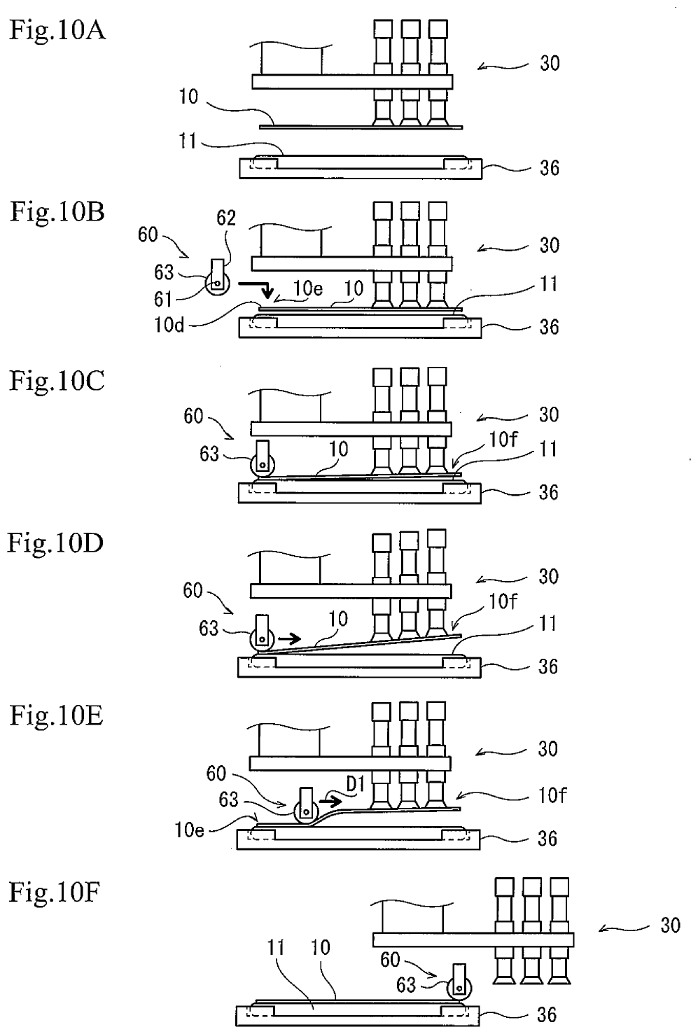

Next, the pasting of the film 10 to the terminal 11 is performed. FIGS. 10(a) to 10(f) each illustrates a side view of the film 10, the terminal 11, the suction unit 30, and the pressing unit 60 at each process when pasting the film 10.

As illustrated in FIGS. 10(a) and 10(b), while the film 10 after the protection sheet 10a is peeled off is sucked and held by the suction unit 30, the suction unit 30 is moved to position the film 10 at a position close to the surface of the terminal 11 (S4).

As illustrated in FIG. 10(b), when the film 10 reaches the position close to the terminal 11, the film 10 is positioned at the position where the film 10 is pasted by finely adjusting the position of the suction unit 30. At this time, since the film 10 is positioned at the position close to and above the surface of the terminal 11, the exact positioning for the pasting position can be performed. Thus, the film 10 is positioned at the pasting position of the terminal 11.

When the film 10 is positioned at the pasting position, the pressing of the film 10 is performed by the pressing unit 60, as illustrated in FIG. 10(c). By pressing by the pressing unit 60 an area of the film 10 near one end 10d, the area 10e of the film 10 is pasted to the terminal 11 (S5).

In the pressing of the film 10 by the pressing unit 60, by moving the multi-function hand part 70 while rotating the multi-function hand part 70, the pressing unit 60 is positioned at a position corresponding to the area near one end 10d of the film 10. In this embodiment, the pressing unit 60 is positioned so as to be located at the position and become the posture where, by rolling the roller 63 in one direction, the pressing unit 60 can press throughout the film 10.

Then, a portion of the film 10 to be pasted is inclined with respect to the surface of the terminal 11 at the pasting position. When inclining the film 10, the pressing unit 60 is moved so as to press one area 10e of the film 10, and bring one area 10e of the film 10 into contact with the terminal 11 by pressing. At the same time, the suction unit 30 is moved so that the other area 10f of the film 10 is raised and separated from the terminal 11.

As illustrated in FIG. 10(d), while one area 10e of the film 10 is pressed against the terminal 11, a portion of the film 10 held by the suction unit 30 is moved so as to be separated from the terminal 11. Where the area 10e of the film 10 is pasted to the terminal, the other area 10f is raised.

When the film 10 is inclined, the pressing unit 60 presses the portion of the film 10 to be pasted, and sequentially pastes the adhesive part of the film 10 in a pasting direction D1 from one area to the other area.

As illustrated in FIG. 10(e), while the pressing unit 60 presses the film 10 toward the terminal 11, the pressing unit 60 moves toward the other area 10f of the film 10. By moving the pressing unit 60 in the pasting direction D1 while pressing the film 10 by the pressing unit 60, the pressing position of the pressing unit 60 is moved in the pasting direction D1 from one area 10e to the other area 10f. Thus, the adhesive part of the film 10 is sequentially brought in contact with the terminal 11 in the pasting direction D1 to paste the film 10 to the terminal 11. Thus, the film is sequentially pasted in the pasting direction D1 (S7) (pasting process).

As illustrated in FIG. 10(f), when the pressing of the pressing unit 60 is performed throughout the film 10 from one area 10e to the other area 10f, and the pasting of the entire film 10 to the terminal 11 is performed, the pasting of the film 10 is finished.

Next, the wiping is performed by the wiper unit 40 to the surface of the terminal 11 where the film 10 is pasted (S8).

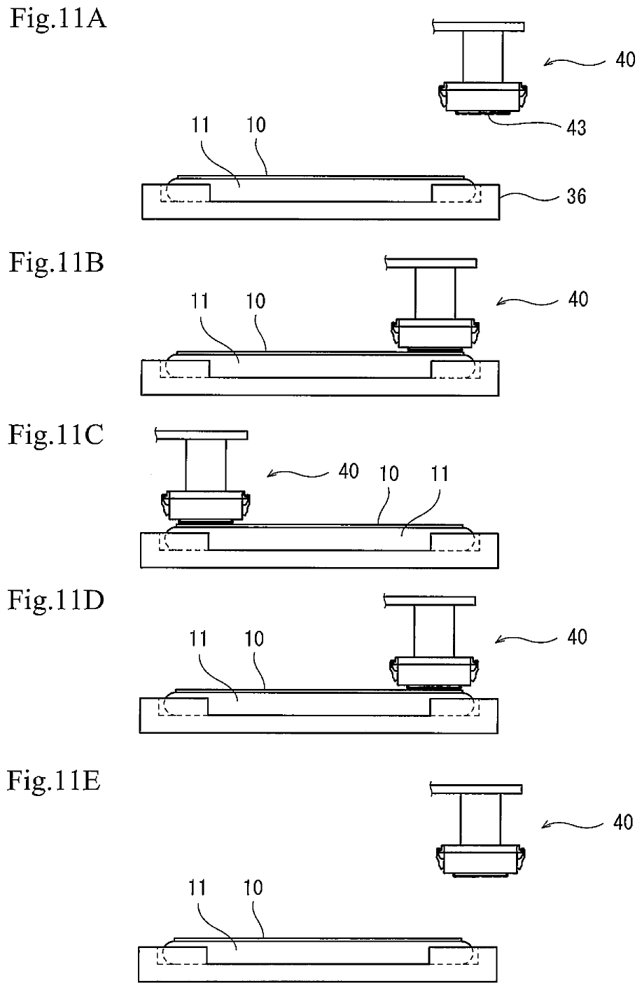

FIGS. 11(a) to 11(e) each illustrates a side view of the film 10, the wiper unit 40, and the terminal 11 at each process when the wiper unit 40 wipes the surface of the terminal where the film 10 is pasted.

When performing the wiping of the surface of the terminal 11 where the film 10 is pasted, the wiper unit 40 is moved and is brought in contact with the surface of the terminal 11 where the film 10 is pasted, as illustrated in FIGS. 11(a) and 11(b). In the wiping of the wiper unit 40, by moving the multi-function hand part 70 while rotating the multi-function hand part 70, the wiper unit 40 is positioned at a position corresponding to the terminal 11 where the film 10 is pasted.

In this embodiment, the wiper unit 40 is brought in contact with the surface at an end of the film 10 which is pasted to the terminal 11.

As illustrated in FIG. 11(b), the wiper unit 40 is moved until the wiper unit 40 reaches a position where the wiping part 43 of the wiper unit 40 contacts the surface of the terminal 11. When the wiper unit 40 reaches the position where the wiping part 43 of the wiper unit 40 contacts the surface of the terminal 11, the wiping part 43 reciprocates while it contacts the surface of the terminal 11 where the film 10 is pasted, as illustrated in FIGS. 11 (c) and 11(d). Thus, the spots, such as dust and oil, on the surface of the film 10 pasted to the terminal 11 can be wiped off by the wiping part 43, and the surface of the film 10 pasted to the terminal 11 can be cleaned. Thus, the wiper unit 40 is configured to perform the wiping of the opposite surface of the film 10 from the surface where the adhesive part is formed, when the film 10 is pasted to the terminal 11.

When the wiping of the wiper unit 40 is finished after the wiper unit 40 reciprocates a given number of times on the surface of the terminal 11, the wiper unit 40 is moved so as to be separated from the terminal 11, as illustrated in FIG. 11(e). When the wiping of the terminal 11 where the film 10 is pasted is finished, the pasting process of the film 10 to the terminal 11 is finished.

According to the pasting of the film 10 by the film pasting device 100 of the present disclosure, since the film 10 is sequentially pasted in the pasting direction D1 while the film 10 being inclined, the pasting is performed while eliminating air from between the film 10 and the terminal 11. Therefore, when pasting the film 10 to the terminal 11, the residual air between the film 10 and the surface of the terminal 11 can be reduced.

In this embodiment, the film 10 is formed of a transparent material, and the screen of the terminal 11 is located at a position directly below the pasted portion of the film 10. A user needs to visually observe an image displayed on the screen through the film 10. If air remained between the film 10 and the surface of the terminal 11, when the image is seen through the film 10, the color changes in the portion in which the air remained, and it becomes impossible to visually observe the image correctly. Therefore, the quality of the terminal 11 may deteriorate. According to the film pasting device 100 of the present disclosure, the film 10 can be pasted to the terminal 11, while reducing the residual air. Therefore, the film 10 is pasted to the terminal 11 in the state where the image throughout the film 10 is visually observed correctly, without air remaining between the film 10 and the terminal 11. Therefore, the quality of the terminal 11 to which the film 10 is pasted can be improved.

Moreover, the film 10 can be pasted to the terminal 11 by controlling the movement and operation of the robotic arm 13, and the suction of the suction unit 30 in accordance with the given flow. Therefore, the pasting of the film 10 to the terminal 11 can be performed with the reduced residual air bubbles by the simple method.

Therefore, the film 10 can be pasted to the terminal 11 at high speed. Therefore, when pasting the film to the terminal, such as a cellular phone, in a shop, the user's waiting time can be reduced. Therefore, the user's inconvenience can be reduced.

Moreover, since the film 10 can be pasted to the terminal 11 at high speed, many films 10 can be pasted to many terminals 11 in a short time. Thus, since the films 10 can be pasted to the terminals 11 in a short time, the operation cost of the film pasting device 100 required for pasting the films 10 to the terminals 11 can be reduced.

Moreover, in this embodiment, the film 10 is held by the suction of the suction unit 30, and the held film 10 is pressed by the roller 63 to paste the film 10. Therefore, the pasting of the film 10 can be performed, regardless of the size and shape of the terminal. For example, even when the shape of the terminal 11 is changed and the size of the film 10 is changed, the film can be pasted, immediately responding to the changes. It can also deal with, for terminals of a certain model, while continuously pasting films corresponding to the model, pasting of films of terminals of a different model. Thus, the pasting of the film to the terminal can be performed corresponding to the terminals of any model, and it can be used as a highly-versatile film pasting device 100.

Note that, although the film 10 is formed of the transparent material in the embodiment, the present disclosure is not limited to this material. The film may be formed of material of which a portion directly underneath the portion to which the film is pasted does not need to be visually observed, instead of being transparent. Even in such a case, according to the film pasting device 100 of the present disclosure, the residual air between the film and an object to which the film is pasted is reduced. Since the film is pasted without the air remaining between the film and the object, surface waviness etc. does not occur in the film, and the film can be pasted with sufficient accuracy conforming to the shape of the object. Therefore, the appearance of the portion to which the film is pasted can be improved. Thus, the quality of the object to which the film is pasted can be improved.

Moreover, although in the above embodiment the structure in which the film 10 is held by the suction of the suction unit 30, and the film 10 held by the suction is pasted to the terminal is described, the present disclosure is not limited to the above embodiment. The film pasting device 100 may have an adhesion part, and the adhesion part may hold the film 10 by adhesion. Moreover, the film pasting device 100 may be configured to hold the film 10 by other structures, as long as it is possible to hold the film 10.

Moreover, although in the above embodiment the pressing unit 60 has the roller 63 which is rollable toward the terminal 11 while pressing the film 10 from the other surface side opposite from one surface side where the adhesive part is formed, the present disclosure is not limited to this structure. The pressing unit 60 may be configured so that it pastes the film 10 by sliding on the other surface of the film 10 while pressing from the other surface side an area of the film 10 which contacts the terminal 11. The pressing unit 60 may have, for example, a spatula, as what pastes the film by sliding on the other surface of the film 10. The spatula may be configured to push out and eliminate air from the space between the film 10 and the terminal 11 to reduce the residual air between the film 10 and the terminal 11. Alternatively, the pressing unit 60 may have a member, such as a brush, as what pastes the film by sliding on the other surface of the film 10. The member, such as a brush, may be configured to push out and eliminate the air from the space between the film 10 and the terminal 11. Moreover, the film pasting device 100 may have a pressing unit of other structures, as long as it can eliminate the air from the space between the film 10 and the terminal 11.

Moreover, although in the embodiment the suction unit 30 is attached to the first robotic arm 13A, and the wiper unit 40, the peeling unit 50, and the pressing unit 60 are attached to the second robotic arm 13B, the present disclosure is not limited to this structure. Since the suction of the suction unit 30 and the wiping of the wiper unit 40 are not necessarily performed in parallel, the suction unit 30 and the wiper unit 40 may be configured to be attached to the same robotic arm, and the wiper unit may be attached to either the first robotic arm 13A or the second robotic arm 13B. Therefore, for example, the suction unit 30 and the wiper unit 40 may be configured to be attached to the first robotic arm 13A, and the peeling unit 50 and the pressing unit 60 may be configured to be attached to the second robotic arm 13B. Moreover, other combinations of the unit attached to the first robotic arm 13A and the unit attached to the second robotic arm 13B may be adopted, as long as the film 10 can be pasted to the terminal 11.

### DESCRIPTION OF REFERENCE CHARACTERS

14 Control Part
30 Suction Unit
60 Pressing Unit

1. A film pasting device, comprising:
a movable holding part configured to hold a film formed with an adhesive part having adhesiveness in one surface of the film;
a moveable pressing part configured to press an area of the film that contacts a target object from other surface side opposite from the one surface when the adhesive part contacts the target object; and
a control part configured to control movement of the holding part and movement of the pressing part,
wherein the control part controls the movements of the holding part and the pressing part so that the holding part holding the film moves to position the film at a pasting position of the target object, and incline a portion of the film to be pasted with respect to a surface of the pasting position of the target object, and the pressing part sequentially pastes the adhesive part in a pasting direction from one area to the other area, while pressing the portion of the film to be pasted, to bring the adhesive part into contact with the target object and past the film to the target object.

2. The film pasting device of claim 1, wherein the control part controls the movements of the holding part and the pressing part so that the pressing part moves to press the one area of the film to bring the one area into contact with the target object, and the holding part moves the other area of the film in a direction separating from the target object to incline the film.

3. The film pasting device of claim 1, wherein the control part controls the movements of the holding part and the pressing part so that the pressing part moves in the pasting direction while the pressing part presses the film to move a pressing position of the pressing part in the pasting direction.

4. The film pasting device of claim 1, wherein the pressing part has a roller configured to roll on an area of the film contacting the target object, while pressing the area of the film from the other surface side.

5. The film pasting device of claim 1, wherein the pressing part is configured to paste the film by sliding on the other surface of the film, while pressing from the other surface side an area of the film contacting the target object.

6. The film pasting device of claim 1, wherein the holding part has a suction part configured to suck the other surface of the film.

7. The film pasting device of claim 1, wherein the holding part has an adhesion part configured to hold the film by adhering to the other surface of the film.

8. The film pasting device of claim 1, wherein the film has a protection sheet configured to protect the adhesive part by covering the one surface of the film, the protection sheet having a grip part located in an area separated from the adhesive part and to be gripped when the protection sheet is peeled off from the film, and
the device further comprising a peeling part configured to peel off the protection sheet from the film by griping the grip part and moving in a direction so as to separate from the film.

9. The film pasting device of claim 1, further comprising a wiper member configured to wipe off the other surface of the film when the film is pasted to the target object.

10. The film pasting device of claim 9, wherein the wiper member wipes off the pasting position of the target object before the film is pasted to the target object.

11. The film pasting device of claim 1, comprising a robot including a first robotic arm and a second robotic arm, the holding part being attached to the first robotic arm, and the pressing part being attached to the second robotic arm,
wherein the control part controls the movements of the holding part and the pressing part by controlling movements of the first robotic arm and the second robotic arm.

12. The film pasting device of claim 8, comprising a robot including a first robotic arm and a second robotic arm, the holding part being attached to the first robotic arm, and the pressing part and the peeling part being attached to the second robotic arm,
wherein the control part controls the movements of the holding part, the pressing part, and the peeling part by controlling movements of the first robotic arm and the second robotic arm.

13. The film pasting device of claim 9, comprising a robot including a first robotic arm and a second robotic arm, the holding part being attached to the first robotic arm, the pressing part being attached to the second robotic arm, and the wiper member being attached to one of the first robotic arm and the second robotic arm,
wherein the control part controls the movements of the holding part, the pressing part, and the wiper member by controlling movements of the first robotic arm and the second robotic arm.

14. A method of pasting a film to a target object by using a film pasting device including a holding part configured to hold the film formed with an adhesive part having adhesiveness in one surface of the film and be movable while holding the film, and a pressing part configured to press the film from the other surface side opposite from the one surface, the method comprising the steps of:
holding the film by the holding part; and
moving the film held by the holding part to a pasting position of the target object, inclining a portion of the film to be pasted with respect to a surface of the pasting position of the target object, and sequentially pasting by the pressing part the adhesive part in a pasting direction from one area to the other area, while pressing by the pressing part the portion of the film to be pasted, to bring the adhesive part into contact with the target object and paste the film to the target object.
